(19) United States
(12) Patent Application Publication
(10) Pub. No.: US 2026/0125591 A1
(43) Pub. Date: May 7, 2026

(54) INORGANIC LATENT HEAT STORAGE MATERIAL COMPOSITION AND USE THEREOF

(71) Applicant: KANEKA CORPORATION, Osaka (JP)

(72) Inventor: Tomoharu Asano, Osaka (JP)

(73) Assignee: KANEKA CORPORATION, Osaka (JP)

(21) Appl. No.: 19/431,016

(22) Filed: Dec. 23, 2025

Related U.S. Application Data
(63) Continuation of application No. PCT/JP2024/017928, filed on May 15, 2024.

(30) Foreign Application Priority Data
Jul. 4, 2023 (JP) 2023-110037
Mar. 22, 2024 (JP) 2024-046839

(51) Int. Cl. C09K 5/06; B65D 81/18; B65D 81/38

(52) U.S. Cl. CPC C09K 5/063; B65D 81/18; B65D 81/3813

(57) ABSTRACT

An inorganic latent heat storage material composition having high thermal stability is provided. The inorganic latent heat storage material composition contains calcium chloride hexahydrate and a metal soap including strontium ions and anions derived from fatty acids.

### TECHNICAL FIELD

One or more embodiments of the present invention relate to an inorganic latent heat storage material composition and use thereof.

### BACKGROUND

In recent years, from an environmental perspective, active research and development have been conducted in the technical field of building materials so as to more effectively utilize thermal energy etc. generated during indoor heating.

Some reactive substances, such as adhesives, precision instruments, semiconductors, pharmaceuticals, investigational drugs, and specimens may be handled within a given range of temperatures (hereinafter may be referred to as “control temperature”). Such articles may also be each referred to as “temperature control target article”. In a case where a temperature control target article is transported or stored, it is preferable to keep the temperature control target article cold or warm within the range of control temperatures for a given period of time.

Conventionally, several latent heat storage material compositions (may also be referred to as “phase change materials (PCM)”) have been developed which are suitable to (i) be applied to wall materials, floor materials, ceiling materials, etc. and/or (ii) store or transport, at constant or substantially constant temperatures, temperature control target articles that require temperature control at control temperatures exceeding 0° C.

For example, inorganic latent heat storage material compositions disclosed in Patent Documents 1 and 2 are known.

### PATENT LITERATURE

### Patent Literature 1

International Publication No. WO 2022/158484

### Patent Literature 2

Japanese Patent Application Publication Tokukai No. 2021-143304

Conventional inorganic latent heat storage material compositions as described above still have room for improvement from the perspective of thermal stability.

### SUMMARY

One or more embodiments of the present invention have been made in view of the above to provide an inorganic latent heat storage material composition having high thermal stability.

As a result of conducting diligent studies, the inventors of the present invention completed one or more embodiments of the present invention.

That is, an inorganic latent heat storage material composition in accordance with one or more embodiments of the present invention is an inorganic latent heat storage material composition containing: calcium chloride hexahydrate; and a metal soap which is composed of strontium ions and anions that are derived from a fatty acid.

A method for producing an inorganic latent heat storage material composition in accordance with one or more embodiments of the present invention is a method for producing an inorganic latent heat storage material composition, the method including any one of the following mixing steps (A) to (C):
the mixing step (A) of mixing calcium chloride hexahydrate and a metal soap which is composed of strontium ions and anions that are derived from a fatty acid;
the mixing step (B) of mixing a dispersion liquid containing a metal soap which is composed of strontium ions and anions that are derived from a fatty acid and at least one selected from the group consisting of calcium chloride anhydride, calcium chloride dihydrate, and calcium chloride tetrahydrate; and
the mixing step (C) of mixing a metal soap which is composed of strontium ions and anions that are derived from a fatty acid, water, and at least one selected from the group consisting of calcium chloride anhydride, calcium chloride dihydrate, and calcium chloride tetrahydrate.

In one or more embodiments of the present invention, it is possible to provide an inorganic latent heat storage material composition having high thermal stability.

### BRIEF DESCRIPTION OF THE DRAWINGS

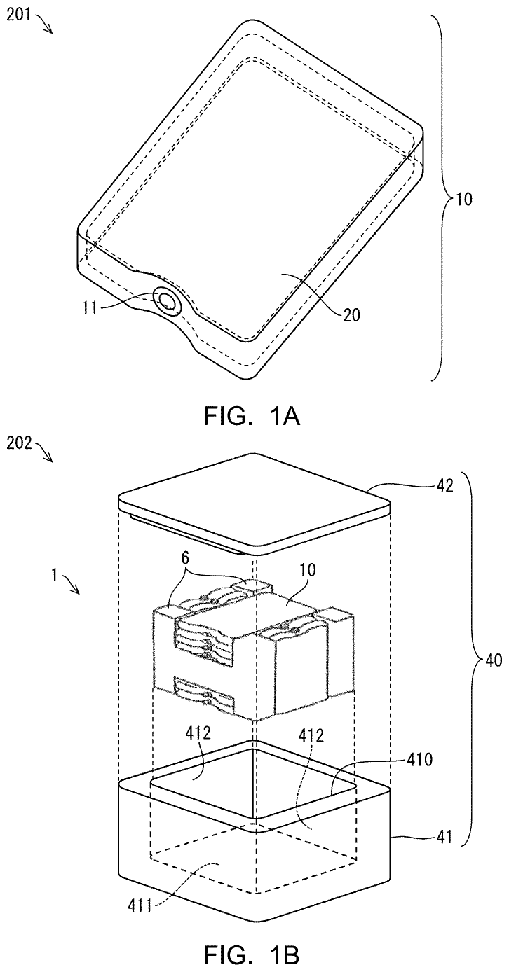

201 of FIG. 1A is a perspective view schematically illustrating an example of a heat storage material in accordance with one or more embodiments of the present invention. 202 of FIG. 1B is an exploded perspective view schematically illustrating an example of a transport container in accordance with one or more embodiments of the present invention.

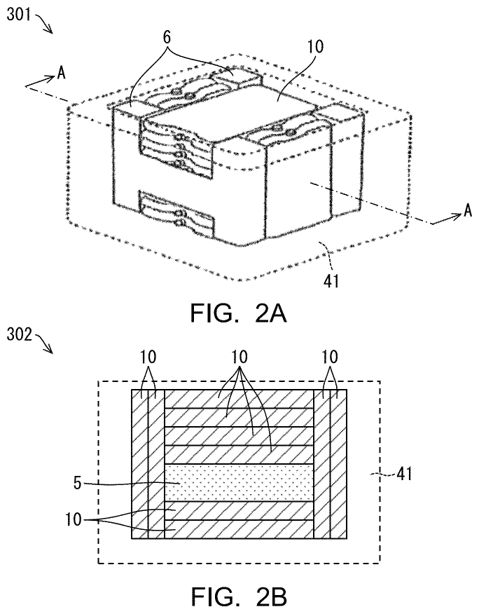

301 of FIG. 2A is a perspective view schematically illustrating the inside of the transport container in accordance with one or more embodiments of the present invention. 302 of FIG. 2B is a cross-sectional view schematically illustrating a cross section taken along the line A-A in 301 of FIG. 2A.

### DETAILED DESCRIPTION

The following description will discuss one or more embodiments of the present invention. The present invention is not, however, limited to these embodiments. The present invention is not limited to the configurations described below, but may be altered in various ways within the scope of the claims. The present invention also encompasses, in its technical scope, any embodiments or example derived by combining technical means disclosed in differing embodiments or examples. Further, it is possible to form a new technical feature by combining technical means disclosed in any embodiments. All academic and patent documents cited in the present specification are incorporated herein by reference. Any numerical range expressed as “A to B” herein means “not less than A (inclusive of A and greater than A) and not more than B (inclusive of B and smaller than B)”, unless otherwise stated.

### 1. Technical Idea of One or More Embodiments of the Present Invention

The purposes of PCM include: (i) stably maintaining a temperature control target article at a given temperature, such as room temperature (for example, 15° C. to 30° C.), and/or (ii) maintaining a living space at a given temperature (for example, 15° C. to 30° C.). In the present specification, transporting or storing a temperature control target article stably at a given temperature (for example, at a constant temperature or substantially constant temperature) may be referred to as “constant-temperature transportation”, and an application for constant-temperature transportation may be referred to as “constant-temperature transportation application”.

As latent heat storage material compositions, organic latent heat storage material compositions have mainly been used in the current situation.

However, organic latent heat storage material compositions require further improvement for constant-temperature transportation applications where they are used in a one-way manner, for example, for the following reasons: (i) the latent heat storage material compositions are flammable; (ii) the raw materials of the latent heat storage material compositions often fall under hazardous materials subject to legal regulation; (iii) the latent heat storage material compositions cause high environmental loads in the event of leakage; and (iv) the raw materials of the latent heat storage material compositions are high-cost.

Therefore, in the technical field of latent heat storage material compositions, there is an increasing demand for inorganic latent heat storage material compositions, as latent heat storage material compositions which can address all of the above (i) to (iv) found in organic latent heat storage material compositions. As inorganic latent heat storage material compositions, several inorganic latent heat storage material compositions are known, such as those disclosed in the above Patent Literatures 1 and 2.

However, the inventors of the present invention uniquely found that conventional inorganic latent heat storage material compositions have low thermal stability, and for example, are easily deteriorated by heat.

Accordingly, the inventors of the present invention conducted diligent studies so as to obtain an inorganic latent heat storage material composition having high thermal stability.

As a result of diligent studies, the inventors of the present invention uniquely obtained the novel findings that an inorganic latent heat storage material composition containing a metal soap which is composed of strontium ions and anions that are derived from a fatty acid surprisingly exhibits high thermal stability, and consequently completed the invention.

### 2. Inorganic Latent Heat Storage Material Composition

An inorganic latent heat storage material composition in accordance with one or more embodiments of the present invention contains (i) calcium chloride hexahydrate and (ii) a metal soap which is composed of strontium ions and anions that are derived from a fatty acid.

In the present specification, the “inorganic latent heat storage material composition” may be referred to as “composition”, and the “inorganic latent heat storage material composition in accordance with one or more embodiments of the present invention” may be referred to as “the present composition”.

Since the present composition has the above configuration, the present composition has the advantage of high thermal stability.

In the present specification, the “high thermal stability” is intended to mean that, after a thermal stability test, the difference (Δsupercooling) between the solidifying temperature and the supercooling temperature of the composition is small (for example, less than 5.0° C.). That is, the present composition has the advantage that, even after the thermal stability test, Δsupercooling of the composition is small. In one or more embodiments the of present invention, Δsupercooling of the composition after the thermal stability test may be less than 5.0° C., 4.5° C. or less, 4.0° C. or less, 3.5° C. or less, 3.0° C. or less, 2.5° C. or less, or less than 2.5° C. A specific method of the thermal stability test, a method for measuring the solidifying temperature, and a method for measuring the supercooling temperature will be described in detail in the examples below.

The present composition can be repeatedly used. Note, here, that the expression “repeatedly used” regarding the inorganic latent heat storage material composition is intended to mean repeated melting and solidification of the composition. It is preferable that, even after the present composition is repeatedly used (for example, after a cycle test), the difference (Δsupercooling) between the solidifying temperature and the supercooling temperature of the composition is small (for example, less than 5.0° C.). In one or more embodiments of the present invention, Δsupercooling of the composition after the cycle test may be 4.5° C. or less, 4.0° C. or less, 3.5° C. or less, 3.0° C. or less, 2.5° C. or less, or less than 2.5° C. A specific method of the cycle test will be described in detail in the examples below.

It is preferable that, also before the present composition is repeatedly used (for example, immediately after the composition is produced or before the composition is used (for example, before the composition is solidified)), the difference (Δsupercooling) between the solidifying temperature and the supercooling temperature of the composition is small (for example, less than 5.0° C.). In the present specification, the expression “before being repeatedly used” may be referred to as “initial stage”. In one or more embodiments of the present invention, Δsupercooling of the composition at the initial stage may be 4.5° C. or less, 4.0° C. or less, 3.5° C. or less, 3.0° C. or less, 2.5° C. or less, or less than 2.5° C.

After the thermal stability test, after the cycle test, or immediately after the composition is produced or before the composition is used, the lower limit of the difference (Δsupercooling) between the solidifying temperature and the supercooling temperature of the composition is not particularly limited, and may be, for example, 0° C. That is, in any of the above cases, there may be no difference between the solidifying temperature and the supercooling temperature of the composition.

### (2-1. (a) Calcium Chloride Hexahydrate)

The present composition contains calcium chloride hexahydrate in the largest amount. Accordingly, the calcium chloride hexahydrate can be regarded as the main agent of the present composition, and may be referred to as “main agent”.

Since the calcium chloride hexahydrate is used as the main agent, the present composition has the advantage that the composition having a melting temperature of 15° C. to 30° C. can be easily produced.

In addition to the present composition containing the calcium chloride hexahydrate as the main agent, inorganic latent heat storage material compositions containing, for example, sodium acetate trihydrate, sodium sulfate decahydrate, disodium hydrogen phosphate dodecahydrate, sodium carbonate decahydrate, or the like as the main agent are known. Compared with such compositions containing inorganic salts other than calcium chloride hexahydrate as the main agent, the present composition has the following advantages: (i) the composition can be more suitably used within a temperature range assumed to be an environment in which a human lives (human living environment), (ii) the composition can stably maintain the temperature of a temperature control target article at approximately 15° C. to 30° C., and (iii) the obtained composition has excellent durability and produces less odor.

The amount of the calcium chloride hexahydrate contained in the present composition is not particularly limited, and can be set, as appropriate, on the basis of a desired melting temperature, desired viscosity, and the like. The present composition may contain the calcium chloride hexahydrate in an amount of 50.00% by weight or more, 55.00% by weight or more, 60.00% by weight or more, 65.00% by weight or more, or 70.00% by weight or more, relative to 100% by weight of the composition. In a case where the amount of the calcium chloride hexahydrate contained in the present composition is within the above range, the present composition has, for example, the following advantages: (i) since a latent heat amount per weight is large, the composition functions efficiently as a heat storage material; (ii) the obtained composition can be used in a temperature range assumed for a human living environment; and (iii) the obtained composition has excellent durability and produces less odor. The upper limit of the amount of the calcium chloride hexahydrate contained in the present composition is not particularly limited, and may be, for example, 99.99% by weight or less relative to 100% by weight of the composition.

### (2-2. Metal Soap)

The present composition contains a metal soap which is composed of strontium ions and anions that are derived from a fatty acid. The metal soap can have a function of preventing supercooling of the composition. Therefore, the metal soap can be referred to as “supercooling inhibitor”, “supercooling preventing agent”, “crystal nucleating agent”, “nucleating agent”, or “nucleus forming agent”. Since the present composition contains the metal soap, the present composition has the advantage of high thermal stability.

In the present specification, unless otherwise specified, the term “metal soap” is intended to mean a “metal soap which is composed of strontium ions and anions that are derived from a fatty acid”. More specifically, the metal soap is intended to mean a substance in which strontium ions (cations) and anions that are derived from a fatty acid are ionically bonded.

In the present specification, the fatty acid in the term “anions that are derived from a fatty acid” may be referred to as “fatty acid F”. The fatty acid F is not particularly limited, and examples thereof include conventionally known fatty acids having a hydrocarbon chain and a carboxyl group. The fatty acid F is not limited to linear monocarboxylic acids. The fatty acid F may have a functional group such as a hydroxy group, and may have a cyclic structure.

The hydrocarbon chain in the fatty acid F may be linear, and may include a branched chain.

The hydrocarbon chain in the fatty acid F may be saturated or unsaturated. From the perspective of preventing, for example, decomposition due to oxidation of the hydrocarbon chain, the hydrocarbon chain of the fatty acid F may be a saturated hydrocarbon chain. In other words, the fatty acid F may be a saturated fatty acid.

The number of carbon atoms in the fatty acid F is not particularly limited, but may be 6 or more, 8 or more, 10 or more, or 12 or more. This configuration has the advantage that the metal soap has crystallinity suitable to control the particle size of the metal soap. The number of carbon atoms in the fatty acid F may be 14 or more, 16 or more, or 18 or more.

The upper limit of the number of carbon atoms in the fatty acid F is not particularly limited, but may be 30 or less, 28 or less, 26 or less, 24 or less, 22 or less, 20 or less, or 18 or less. As the number of carbon atoms in the fatty acid F decreases, the cohesive force of the metal soap becomes lower. Thus, it becomes easier to maintain the particle size of the metal soap. Therefore, the upper limit of the number of carbon atoms in the fatty acid F may be 18 or less, 16 or less, or 14 or less.

The fatty acid F may be at least one selected from the group consisting of caprylic acid (n-octanoic acid), capric acid (n-decanoic acid), lauric acid (n-dodecanoic acid), myristic acid (n-tetradecanoic acid), palmitic acid (n-hexadecanoic acid), and stearic acid (n-octadecanoic acid), at least one selected from the group consisting of lauric acid, myristic acid, palmitic acid, and stearic acid, or lauric acid. This configuration has the advantage that the metal soap has suitable crystallinity.

The metal soap may be at least one selected from the group consisting of strontium dicaprylate, strontium dicaprate, strontium dilaurate, strontium dimyristate, strontium dipalmitate, and strontium distearate, at least one selected from the group consisting of strontium dilaurate, strontium dimyristate, strontium dipalmitate, and strontium distearate, or strontium dilaurate. This configuration has the advantage that the metal soap has suitable crystallinity.

In one or more embodiments of the present invention, the amount of the metal soap contained in 100% by weight of the composition is not particularly limited, but may be 0.01% by weight to 0.10% by weight, 0.03% by weight to 0.07% by weight, or 0.03% by weight to 0.05% by weight. This configuration has the advantage that a favorable dispersion state of the metal soap can be formed in the composition.

The metal soap may be a substance obtained by reacting an aqueous solution which contains a strontium salt and an aqueous solution which contains a water-soluble metal salt of the fatty acid. In the present specification, a “water-soluble” substance is intended to mean a substance having a “solubility of 0.01 g/ml or more in water at 25° C.”. Strontium salts are water-soluble. Therefore, in an aqueous solution which contains a strontium salt, the strontium salt can ionize, and strontium ions can exist in the aqueous solution. In an aqueous solution which contains a water-soluble metal salt of a fatty acid, the metal salt can ionize, and anions of the fatty acid (anions that are derived from the fatty acid) can exist in the aqueous solution. Therefore, by, for example, mixing an aqueous solution which contains a strontium salt and an aqueous solution which contains a water-soluble metal salt of a fatty acid so that these aqueous solution undergo a reaction, strontium ions and anions that are derived from the fatty acid can ionically bond in an obtained mixture, and consequently a metal soap can be generated. In other words, by reacting an aqueous solution which contains a strontium salt and an aqueous solution which contains a water-soluble metal salt of a fatty acid, it is highly probable that a metal soap is generated in an obtained mixture. Accordingly, it can be considered that a metal soap exists in a mixture obtained by reacting an aqueous solution which contains a strontium salt and an aqueous solution which contains a water-soluble metal salt of a fatty acid. In contrast, in an aqueous solution which contains a non-water-soluble (i.e., poorly water-soluble) metal salt of a fatty acid, the metal salt cannot ionize, and therefore anions of the fatty acid cannot exist in the aqueous solution. In addition, fatty acids themselves having 8 or more carbon atoms are also poorly water-soluble. Therefore, in an aqueous solution which contains a fatty acid having 8 or more carbon atoms, the fatty acid cannot ionize, and anions of the fatty acid cannot exist in the aqueous solution. In the present specification, a “poorly water-soluble” substance is intended to mean a substance having a “solubility of less than 0.01 g/ml in water at 25° C.”. Therefore, in a case where (i) (i-a) an aqueous solution which contains a non-water-soluble metal salt of a fatty acid or (i-b) an aqueous solution which contains a fatty acid having 8 or more carbon atoms and (ii) an aqueous solution which contains a strontium salt are mixed, a metal soap cannot be formed in an obtained mixture, and it is highly probable that a metal soap is not generated. Accordingly, it can be considered that a metal soap does not exist in a mixture obtained by mixing (i) (i-a) an aqueous solution which contains a non-water-soluble metal salt of a fatty acid or (i-b) an aqueous solution which contains a fatty acid having 8 or more carbon atoms and (ii) an aqueous solution which contains a strontium salt.

Examples of the strontium salt include inorganic salts, such as strontium chloride, strontium chloride hexahydrate, and strontium hydroxide octahydrate. As the strontium salt, one of the above compounds may be used alone, or two or more of the above compounds may be used in combination.

The strontium salt may be at least one selected from the group consisting of strontium chloride and strontium chloride hexahydrate, because it is possible to prevent or reduce corrosion of production facilities and the like.

Examples of the water-soluble metal salt of the fatty acid include alkali metal salts and alkaline earth metal salts. As the water-soluble metal salt of the fatty acid, one of the above compounds may be used alone, or two or more of the above compounds may be used in combination.

The water-soluble metal salt of the fatty acid may be at least one selected from the group consisting of alkali metal salts and alkaline earth metal salts, at least one selected from the group consisting of alkali metal salts, or at least one selected from the group consisting of sodium salts and potassium salts, because it is possible to generate a homogeneous metal soap.

Preferable examples of the fatty acid in the term “water-soluble metal salt of the fatty acid” include fatty acids listed above as the fatty acid F. Therefore, the preferable aspects of the fatty acid F are also preferable for the fatty acid in the term “water-soluble metal salt of the fatty acid”.

The water-soluble metal salt of the fatty acid may be at least one selected from the group consisting of sodium caprylate, sodium caprate, sodium laurate, sodium myristate, sodium palmitate, sodium stearate, potassium caprylate, potassium caprate, potassium laurate, potassium myristate, potassium palmitate, and potassium stearate. This configuration has the advantage that it is possible to generate a homogeneous metal soap.

In a case where the metal soap contained in the present composition is a substance obtained by reacting an aqueous solution which contains a strontium salt and an aqueous solution which contains a water-soluble metal salt of the fatty acid, the concentration of the strontium salt in the aqueous solution which contains the strontium salt, the amount of this aqueous solution used, the concentration of the metal salt in the aqueous solution which contains the water-soluble metal salt of the fatty acid, and the amount of this aqueous solution used are not particularly limited, but may be concentrations and amounts that cause the amount of the metal soap in an obtained mixture (composition) to be within the above preferable range of the amount of the metal soap contained in the composition. In other words, by adjusting the concentration of the strontium salt in the aqueous solution which contains the strontium salt, the amount of this aqueous solution used, the concentration of the metal salt in the aqueous solution which contains the water-soluble metal salt of the fatty acid, and the amount of this aqueous solution used, it is possible to adjust the amount of the metal soap contained in the obtained mixture (composition) within a desired range.

The volume average particle size of the metal soap in the present composition is not particularly limited, but may be 0.01 μm to 500.00 μm, 0.10 μm to 100.00 μm, or 0.10 μm to 10.00 μm. This configuration has the following advantages: favorable nucleation can be achieved by the metal soap serving as a crystal nucleating agent; and a suitable dispersion state of the metal soap can be formed in the composition. Note that the volume average particle size of the metal soap in the composition can be measured with use of a particle size distribution measurement device which employs laser diffraction and/or dynamic light scattering.

### (2-3. Inorganic Salt S)

In addition to the calcium chloride hexahydrate and the metal soap, the present composition may further contain at least one inorganic salt selected from the group consisting of bromide salts and chloride salts. In the present specification, the “at least one inorganic salt selected from the group consisting of bromide salts and chloride salts” may be referred to as “inorganic salt S”.

The inorganic salt S can have (i) the function of adjusting the melting temperature and/or the solidifying temperature of the composition and/or (ii) the function of preventing supercooling of the composition. A “substance that can adjust the melting temperature and/or the solidifying temperature of the composition” may be referred to as “melting point adjusting agent” or a “solidifying point decreasing agent”. A “substance that can prevent supercooling of the composition” may also be referred to as “supercooling inhibitor”, “supercooling preventing agent”, “crystal nucleating agent”, “nucleating agent”, or “nucleus forming agent”. That is, the inorganic salt S can be referred to as “melting point adjusting agent” or “solidifying point decreasing agent” and/or “supercooling inhibitor”, “supercooling preventing agent”, “crystal nucleating agent”, “nucleating agent”, or “nucleus forming agent”.

In the present specification, the above-described calcium chloride hexahydrate and the above-described strontium salt, as well as a cellulose derivative, a benzoate, and a main agent precursor, which are described later, are not included in the inorganic salt S. For example, the calcium chloride hexahydrate, strontium bromide and strontium chloride which are each a strontium salt, and calcium chloride anhydride, calcium chloride dihydrate, and calcium chloride tetrahydrate which are each a main agent precursor are each not regarded as the inorganic salt S. Therefore, the amounts of the calcium chloride hexahydrate, strontium bromide and strontium chloride which are each a strontium salt, and calcium chloride anhydride, calcium chloride dihydrate, and calcium chloride tetrahydrate which are each a main agent precursor are not included in the total amount of the inorganic salt S used.

The bromide salts may be water-soluble inorganic salts, and examples thereof include metal bromides and ammonium bromide.

Examples of the metal bromides include lithium bromide, sodium bromide, potassium bromide, calcium bromide, magnesium bromide, iron bromide, zinc bromide, and barium bromide. As a bromide salt, one of the above compounds may be used alone, or two or more of the above compounds may be used in combination.

Among the above bromide salts, sodium bromide, potassium bromide, ammonium bromide, and the like make it possible to adjust the melting temperature and/or the solidifying temperature of the composition to be obtained to a desired temperature(s) (for example, 15° C. to 30° C.), even when used in small amounts. Therefore, the bromide salt may include at least one selected from the group consisting of sodium bromide, potassium bromide, and ammonium bromide, may be at least one selected from the group consisting of sodium bromide, potassium bromide, and ammonium bromide, or may be sodium bromide and potassium bromide.

The chloride salts may be water-soluble inorganic salts, and examples thereof include metal chlorides and ammonium chloride. Examples of the metal chlorides include lithium chloride, sodium chloride, potassium chloride, magnesium chloride, iron chloride, zinc chloride, aluminum chloride, barium chloride, and cobalt chloride. As a chloride salt, one of the above compounds may be used alone, or two or more of the above compounds may be used in combination.

The chloride salt may include sodium chloride, and may be sodium chloride, because sodium chloride is readily available and widely used as a melting point adjusting agent.

Among the above inorganic salts S, sodium bromide, potassium bromide, calcium bromide, ammonium bromide, iron bromide, zinc bromide, barium bromide, sodium chloride, potassium chloride, magnesium chloride, iron chloride, zinc chloride, and cobalt chloride can each function as a melting point adjusting agent. Among the above inorganic salts S, sodium chloride and barium chloride can each function as a supercooling inhibitor. That is, sodium chloride can function as both a “melting point adjusting agent” and a “supercooling inhibitor”.

The inorganic salt S may be at least one selected from the group consisting of sodium bromide, potassium bromide, potassium chloride, and sodium chloride, or at least one selected from the group consisting of potassium bromide and potassium chloride, because these inorganic salts make it possible to adjust the melting temperature and/or the solidifying temperature of the composition to be obtained to a desired temperature(s) (for example, 15° C. to 30° C.), even when used in small amounts.

The total amount of the inorganic salt S contained in the present composition is not particularly limited, and can be selected, as appropriate, in accordance with the amount of the calcium chloride hexahydrate contained in the composition. The present composition may contain the inorganic salt S in a total amount of 1.0% by weight to 45.0% by weight, 2.0% by weight to 40.0% by weight, 3.0% by weight to 35.0% by weight, or 5.0% by weight to 30.0% by weight, relative to 100% by weight of the composition. This configuration has the following advantages: (i) when the obtained composition is used for a building material such as a wall material, a floor material, a ceiling material, and a roof material, it is possible to maintain the temperature of a space near this building material member or a space covered with the building material at an appropriate temperature (for example, 15° C. to 30° C.) with high accuracy and (ii) it is possible for the obtained composition to stably maintain the temperature of a temperature control target article at approximately 15° C. to 30° C.

The present composition may further include a melting point adjusting agent (hereinafter may be referred to as “another melting point adjusting agent”) other than the inorganic salt S that can function as a melting point adjusting agent. Examples of another melting point adjusting agent include (i) ammonium salts other than ammonium bromide and ammonium chloride, (ii) metal halides other than metal bromides and metal chlorides, (iii) metallic nonhalides, and (iv) urea.

From the perspective of excellent handleability, low environmental load, and reduced odor, the amount of an ammonium salt contained in the present composition may be small. The amount of the ammonium salt contained in the present composition may be 1.00% by weight or less, 0.50% by weight or less, 0.10% by weight or less, 0.01% by weight or less, or 0.00% by weight, relative to 100% by weight of the total weight of the composition.

### (2-4. Lower Alcohol)

In addition to the calcium chloride hexahydrate and the metal soap, the present composition may further contain a lower alcohol. The lower alcohol can have the function of adjusting the melting temperature and/or the solidifying temperature of the composition. That is, the lower alcohol can be referred to as “melting point adjusting agent” or “solidifying point decreasing agent”.

Examples of the lower alcohol include alcohols having 5 or fewer carbon atoms. Specific examples of the lower alcohol include methanol, ethanol, 2-propanol, ethylene glycol, and glycerol. Among these alcohols, the lower alcohol may be ethanol.

The amount of the lower alcohol contained in the present composition is not particularly limited, and can be set, as appropriate, in accordance with the amount of the calcium chloride hexahydrate in the composition. The present composition may contain the lower alcohol in an amount of 0.50% by weight to 5.00% by weight, or 1.00% by weight to 3.00% by weight, relative to 100% by weight of the composition. This configuration has the advantage that the melting temperature can be easily adjusted.

### (2-5. Cellulose Derivative)

In addition to the calcium chloride hexahydrate and the metal soap, the present composition may further contain a cellulose derivative. The cellulose derivative can have the function of increasing the viscosity of the composition and/or the function of rendering the composition gel-like. A “substance which can increase the viscosity of a composition” may be referred to as “thickener”. A “substance which can render a composition gel-like” may be referred to as “gelling agent”. That is, the cellulose derivative can be referred to as “thickener” or “gelling agent”.

In a case where the present composition contains the cellulose derivative, the present composition has the advantage that the composition is in a gel state in an environment in which a temperature exceeds the melting temperature. The cellulose derivative is a thermosetting type thickener. Therefore, in a case where the present composition contains the cellulose derivative, the composition also has the advantage that the composition can be produced efficiently and stably.

Examples of the cellulose derivative may include carboxymethyl cellulose, hydroxyethyl cellulose, hydroxypropyl cellulose, and hydroxypropyl methyl cellulose. The cellulose derivative may include hydroxyethyl cellulose, and may be hydroxyethyl cellulose, because (i) such a cellulose derivative is nonionic and thus does not affect inorganic ions dissolved in the composition and (ii) such a cellulose derivative can render an aqueous solution having a high ion concentration gel-like.

In the composition, depending on the concentration of the inorganic salts contained (the “inorganic salts” in this case are not limited to the above inorganic salt S, but also include other inorganic salts), the inorganic salts may precipitate over time due to temperature changes. In a case where the present composition contains the cellulose derivative, the cellulose derivative can not only (i) render the present composition gel-like but also (ii) efficiently disperse ions of the inorganic salts dissolved in the present composition. Thus, the cellulose derivative can prevent the precipitation of the inorganic salts in the present composition.

The cellulose derivative does not affect the melting behavior and/or the solidification behavior of the composition, and makes it possible for the composition to maintain a high melting latent heat amount. Moreover, in a case where the present composition contains the cellulose derivative, the present composition also has the advantage that the composition is gel-like even after any of the cycle test and the thermal stability test is carried out at an environmental temperature at which the composition is assumed to be used. Furthermore, in a case where the present composition contains the cellulose derivative, the composition is gel-like even when the composition is in a molten state. This makes it possible to maintain the shape of the composition in a certain shape. As a result, even when the composition is in a molten state, the composition is unlikely to contaminate the environment, and it is possible to reduce an environmental load.

The amount of the cellulose derivative contained in the present composition is not particularly limited, and can be set, as appropriate, in accordance with the amount of the calcium chloride hexahydrate in the composition. The present composition may contain the cellulose derivative in an amount of 0.3% by weight to 7.0% by weight, 0.5% by weight to 6.0% by weight, or 1.0% by weight to 5.0% by weight, relative to 100% by weight of the composition. This configuration has the following advantages: (i) it is possible to prevent aggregation and precipitation of salts (both inorganic and organic salts) dissolved in the composition; (ii) the handleability of the composition is good; and (iii) the composition is gel-like in an environment in which a temperature exceeds the melting temperature of the composition.

The present composition may further contain a thickener other than the cellulose derivative. Examples of the thickener other than the cellulose derivative include water-absorbing resins, gelatin, agar, xanthan gum, gum arabic, guar gum, carrageenan, and konjac. Examples of the water-absorbing resins include starch-based resins, acrylate-based resins, and poval-based resins. Examples of silica include fumed silica, precipitated silica, and silica gel.

The calcium chloride hexahydrate, the inorganic salts, and the like contained in the composition are often dissolved in the composition in the form of ions. Therefore, the thickener other than the cellulose derivative may be a nonionic thickener, guar gum and/or dextrin, because these thickeners do not affect the inorganic ions dissolved in the composition.

The total amount of the thickeners (the total amount of the cellulose derivative and the thickener other than the cellulose derivative) contained in the present composition is not particularly limited, and can be set, as appropriate, in accordance with the amount of the calcium chloride hexahydrate in the composition. The total amount of the thickeners contained in the present composition may be 1 part by weight to 10 parts by weight, or 2 parts by weight to 6 parts by weight, relative to 100 parts by weight of the calcium chloride hexahydrate. This configuration has the following advantages: (i) it is possible to prevent aggregation and precipitation of the salts dissolved in the composition; (ii) the handleability of the composition is good; and (iii) the composition is gel-like in an environment in which a temperature exceeds the melting temperature of the composition.

### (2-6. Benzoate)

The present composition may further contain a benzoate. The benzoate can have the function of preventing supercooling of the composition. Therefore, the benzoate can be referred to as “supercooling inhibitor”, “supercooling preventing agent”, “crystal nucleating agent”, “nucleating agent”, or “nucleus forming agent”. The benzoate can also have the function of preventing decay of the composition. Therefore, the benzoate is also referred to as “preservative”.

Examples of the benzoate include (i) metal salts of benzoic acid, such as sodium benzoate, potassium benzoate, lithium benzoate, and calcium benzoate and (ii) ammonium benzoate. As the benzoate, one of the above compounds may be used alone, or two or more of the above compounds may be used in combination.

The benzoate may include at least one selected from the group consisting of metal salts of benzoic acid and ammonium benzoate, may be at least one selected from the group consisting of metal salts of benzoic acid and ammonium benzoate, may be at least one selected from the group consisting of sodium benzoate, potassium benzoate, and ammonium benzoate, or may be sodium benzoate, because these benzoates are highly water-soluble and can further reduce the degree of supercooling of the composition.

The amount of the benzoate contained in the composition is not particularly limited.

### (2-7. Organic Solvent)

The amount of an organic solvent which is contained in the present composition and which is volatile at ordinary temperature (for example, 15° C. to 30° C.) (for example, a monocyclic aromatic compound, more specifically, benzene, toluene, xylene, ethylene benzene, cumene, paracymene, dimethyl phthalate, diethyl phthalate, dipropyl phthalate, and the like) may be small so that the flame retardancy of the composition is further increased. Specifically, the amount of the organic solvent which is contained in 100 parts by weight of the total weight of the present composition and which is volatile at ordinary temperature (for example, a monocyclic aromatic compound) may be 50.0 parts by weight or less, 10.0 parts by weight or less, 5.0 parts by weight or less, 1.0 part by weight or less, 0.5 parts by weight or less, or 0.1 parts by weight or less (the lower limit is 0.0 parts by weight). The total amount of at least one compound which is contained in 100 parts by weight of the total weight of the present composition and which is selected from the group consisting of benzene, toluene, xylene, ethylene benzene, cumene, paracymene, dimethyl phthalate, diethyl phthalate, and dipropyl phthalate may be 50.0 parts by weight or less, 10.0 parts by weight or less, 5.0 parts by weight or less, 1.0 part by weight or less, 0.5 parts by weight or less, or 0.1 parts by weight or less (the lower limit is 0.0 parts by weight).

### (2-8. Other Components)

The present composition may contain, as necessary, another component, provided that the effect of one or more embodiments of the present invention is not impaired. Examples of such another component include solvents, alcohols other than lower alcohols, preservatives, perfumes, coloring agents, defoaming agents, flame retardants, light-resistant stabilizers, ultraviolet ray absorbing agents, storage stabilizers, cell adjusting agents, lubricants, fungicides, antibacterial agents, high molecular polymers, other organic compounds, and other inorganic compounds.

As a solvent, water is preferable so that the flame retardancy of the composition is further increased.

Examples of the alcohols other than lower alcohols include higher alcohols (for example, alcohols having 6 or more carbon atoms, such as capryl alcohol, lauryl alcohol, myristyl alcohol, cetyl alcohol, stearyl alcohol, oleyl alcohol, and linolyl alcohol). The higher alcohols can have the function of adjusting the melting temperature and/or the solidifying temperature of the composition.

### (2-9. Physical Properties)

The following description will discuss the physical properties of the present composition.

### (Melting Temperature)

The melting temperature of the present composition is not particularly limited. The present composition may have a melting temperature of 15° C. to 30° C., 17° C. to 28° C., or 18° C. to 25° C. This configuration has the following advantages: (i) by suitably applying the obtained composition to housing, it is possible to easily adjust a living environment to a comfortable environment with use of the latent heat of the composition; and (ii) it is possible for the obtained composition to stably maintain the temperature of a temperature control target article at approximately 15° C. to 30° C. A method for measuring the melting temperature of the composition will be described in detail in the examples below. The “melting temperature” may also be referred to as “melting point”.

### (Solidifying Temperature)

The solidifying temperature of the present composition is not particularly limited. The present composition may have a solidifying temperature of 15° C. to 30° C., 17° C. to 28° C., or 20° C. to 25° C. This configuration has the following advantages: (i) by suitably applying the obtained composition to housing, it is possible to easily adjust a living environment to a comfortable environment with use of the latent heat of the composition; and (ii) it is possible for the obtained composition to stably maintain the temperature of a temperature control target article at approximately 15° C. to 30° C. The “solidifying temperature” may also be referred to as “solidifying point”. The “melting temperature” and the “solidifying temperature” may collectively be referred to as “phase change temperature” or “phase transition temperature”.

### (2-10. Applications)

The present composition can be suitably used for a latent heat type heat storage material that uses (i) absorption of thermal energy by the composition during phase transition of the composition from a solidified state (solid) to a molten state (liquid or gel state) and (ii) release of thermal energy by the composition during phase transition of the composition from a molten state (liquid or gel state) to a solidified state (solid). The “molten state” can also be referred to as “melted state”.

For example, by absorbing thermal energy during phase transition from a solidified state to a molten state, the present composition can maintain, for example, an indoor temperature at a desired temperature that is equal to or lower than an environmental temperature even in a high-temperature environment (e.g., summer). Furthermore, by releasing thermal energy during phase transition from a molten state to a solidified state, the present composition can maintain, for example, an indoor temperature at a desired temperature that is equal to or higher than an environmental temperature even in a low-temperature environment (e.g., winter). That is, the inorganic latent heat storage material composition in accordance with one or more embodiments of the present invention can maintain, for example, an indoor temperature at a desired temperature (for example, 15° C. to 30° C.) in both a high-temperature environment and a low-temperature environment.

The inorganic latent heat storage material composition in accordance with one or more embodiments of the present invention can be suitably used in various applications where heat storage performance is required, for example, in building material members such as wall materials, floor materials, ceiling materials, and roof materials. Furthermore, the inorganic latent heat storage material composition in accordance with one or more embodiments of the present invention can be suitably used in constant-temperature transportation applications for temperature control target articles such as reactive substances (for example, adhesives), precision instruments, semiconductors, pharmaceuticals, investigational drugs, and specimens.

### 3. Method for Producing Inorganic Latent Heat Storage Material Composition

A method for producing the present composition (preparation method) is not particularly limited. The present composition can be prepared with use of any technique known in the technical field of inorganic latent heat storage material compositions. For example, the present composition can be prepared by mixing the above-described components.

The following description will discuss a method for producing an inorganic latent heat storage material composition in accordance with one or more embodiments of the present invention. Except for the details described below, the descriptions in [2. Inorganic latent heat storage material composition] are applied, as appropriate. In the present specification, the “method for producing an inorganic latent heat storage material composition” may be referred to as “production method”, and the “method for producing an inorganic latent heat storage material composition in accordance with one or more embodiments of the present invention” may be referred to as “the present production method”. In addition, each aspect described as “amount . . . contained” regarding a certain substance (component) in the section [2. Inorganic latent heat storage material composition] can be applied as “amount . . . used”, “amount . . . blended”, or “amount . . . added” regarding the certain substance (component) in the method for producing a composition.

Calcium chloride hexahydrate is commercially available. Calcium chloride anhydride, calcium chloride dihydrate, and calcium chloride tetrahydrate are also each commercially available. In the present production method, only calcium chloride hexahydrate which is a main agent may be used. Alternatively, in the present production method, at least one selected from the group consisting of calcium chloride anhydride, calcium chloride dihydrate, and calcium chloride tetrahydrate may be used in place of a portion or the entirety of the calcium chloride hexahydrate which is the main agent. Each of calcium chloride anhydride, calcium chloride dihydrate, and calcium chloride tetrahydrate (i) forms a hydrate (or a hydrate with a higher hydration number) upon contact with water and (ii) generates heat upon formation of the hydrate, i.e., exhibits positive heat of dissolution. Each of calcium chloride anhydride, calcium chloride dihydrate, and calcium chloride tetrahydrate can form, upon contact with water, calcium chloride hexahydrate which is the main agent. Also in a case where at selected from the group consisting of calcium chloride anhydride, calcium chloride dihydrate, and calcium chloride tetrahydrate is used in place of a portion or the entirety of the calcium chloride hexahydrate, the present composition containing the calcium chloride hexahydrate can be obtained. Therefore, each of calcium chloride anhydride, calcium chloride dihydrate, and calcium chloride tetrahydrate can be referred to as “main agent precursor”. Hereinafter, “calcium chloride anhydride, calcium chloride dihydrate, and calcium chloride tetrahydrate” may be collectively referred to as “main agent precursor”.

Because an the inorganic latent heat storage material composition can be efficiently provided, the method for producing an inorganic latent heat storage material composition in accordance with one or more embodiments of the present invention may include any one of the following mixing steps (A) to (C):
the mixing step (A) of mixing calcium chloride hexahydrate and a metal soap which is composed of strontium ions and anions that are derived from a fatty acid;

the mixing step (B) of mixing a dispersion liquid containing a metal soap which is composed of strontium ions and anions that are derived from a fatty acid and at least one selected from the group consisting of calcium chloride anhydride, calcium chloride dihydrate, and calcium chloride tetrahydrate; and
the mixing step (C) of mixing a metal soap which is composed of strontium ions and anions that are derived from a fatty acid, water, and at least one selected from the group consisting of calcium chloride anhydride, calcium chloride dihydrate, and calcium chloride tetrahydrate.

In the present production method, a device used for mixing the components is not particularly limited, and a known device, such as a mixer (e.g., intensive mixer), a stirrer, and a shaker, can be used, as appropriate.

### (3-1. Mixing Step (A))

In the mixing step (A), at least calcium chloride hexahydrate and a metal soap are mixed. Optionally, water, an inorganic salt S, and/or a cellulose derivative may further be mixed in the mixing step (A). A method and a timing of mixing the water, the inorganic salt S, and/or the cellulose derivative in the mixing step (A) are not particularly limited. For example, the calcium chloride hexahydrate and the inorganic salt S may be pre-mixed to prepare a mixture. Then, the mixture and the metal soap may be mixed. An obtained mixture and the cellulose derivative may further be mixed.

### (3-2. Mixing Step (B))

In the mixing step (B), a dispersion liquid containing a metal soap which is composed of strontium ions and anions that are derived from a fatty acid and at least one main agent precursor are mixed.

In a case where the mixing step (B) is carried out, a dispersion liquid preparing step of preparing the dispersion liquid containing the metal soap may further be carried out prior to the mixing step (B). In other words, the present production method may further include, prior to the mixing step (B), the dispersion liquid preparing step of preparing the dispersion liquid containing the metal soap, and, in the mixing step (B), the dispersion liquid which has been prepared in the dispersion liquid preparing step and at least one selected from the group consisting of calcium chloride anhydride, calcium chloride dihydrate, and calcium chloride tetrahydrate may be mixed.

### (Dispersion Liquid Preparing Step)

The dispersion liquid preparing step is not particularly limited, provided that the dispersion liquid in which the metal soap is dispersed in a solvent (for example, water) can be obtained. The solvent may be water, and the dispersion liquid may be an aqueous dispersion liquid.

The dispersion liquid preparing step may be, for example, a step of mixing water and the metal soap.

As described above, it is possible to prepare a mixture (dispersion liquid) containing the metal soap, by reacting an aqueous solution which contains a strontium salt and an aqueous solution which contains a water-soluble metal salt of the fatty acid. In order to react the aqueous solution which contains the strontium salt and the aqueous solution which contains the water-soluble metal salt of the fatty acid, it is only necessary to bring the aqueous solution which contains the strontium salt and the aqueous solution which contains the water-soluble metal salt of the fatty acid into contact with each other, for example, it is only necessary to simply mix these aqueous solutions. Thus, the dispersion liquid preparing step may be a step of mixing the aqueous solution which contains the strontium salt and the aqueous solution which contains the water-soluble metal salt of the fatty acid. Since it is possible to obtain the dispersion liquid in which the metal soap is uniformly or substantially uniformly dispersed in the solvent, the dispersion liquid preparing step may be a step of preparing the dispersion liquid containing the metal soap by reacting the aqueous solution which contains the strontium salt and the aqueous solution which contains the water-soluble metal salt of the fatty acid.

In the mixing step (B), in place of the calcium chloride hexahydrate which is the main agent, at least one selected from the group consisting of calcium chloride anhydride, calcium chloride dihydrate, and calcium chloride tetrahydrate is used as a main agent precursor. As described above, the main agent precursor reacts with water to be calcium chloride hexahydrate which is the main agent. Thus, the mixing step (B) can also be referred to as a step of preparing a mixture containing the calcium chloride hexahydrate and the metal soap, i.e., an inorganic latent heat storage material composition.

The total amount of calcium chloride anhydride, calcium chloride dihydrate, and calcium chloride tetrahydrate used in the mixing step (B) can be set, as appropriate, so that the amount of the calcium chloride hexahydrate contained in the composition ultimately obtained reaches a desired amount.

The main agent precursor generates heat upon formation of the hydrate, and exhibits positive heat of dissolution. In order to maximize the utilization of the heat generated by hydration of the main agent precursor, it is preferable that the main agent precursor to be mixed with the aqueous solution is solid, not in the form of a solution in which the main agent precursor is pre-dissolved in water. That is, the mixing step (B) may be a step of mixing the dispersion liquid containing the metal soap and at least one solid compound selected from the group consisting of calcium chloride anhydride, calcium chloride dihydrate, and calcium chloride tetrahydrate.

Optionally, water, an inorganic salt S, and/or a cellulose derivative may further be mixed in the mixing step (B). A method and a timing of mixing the water, the inorganic salt S, and/or the cellulose derivative in the mixing step (B) are not particularly limited.

A case where the inorganic salt S is further mixed in the mixing step (B) (hereinafter also referred to as “case A”) is described below. In the case A, the mixing step (B) may be (i) a step of mixing the dispersion liquid of the metal soap, the inorganic salt S, and at least one main agent precursor or (ii) a step of mixing a dispersion liquid in which the inorganic salt S is dissolved and in which the metal soap is dispersed and at least one main agent precursor. From the perspective of increasing homogeneous solubility, in the case A, the mixing step (B) may be the step of mixing the dispersion liquid in which the inorganic salt S is dissolved and in which the metal soap is dispersed and at least one main agent precursor.

In the dispersion liquid preparing step in the case A, the dispersion liquid in which the inorganic salt S is dissolved and in which the metal soap is dispersed is prepared. For example, in the dispersion liquid preparing step in the case A, (i) water, the metal soap, and the inorganic salt S may be mixed to prepare the dispersion liquid in which the inorganic salt S is dissolved and in which the metal soap is dispersed, (ii) an aqueous solution which contains the strontium salt and the inorganic salt S and the aqueous solution which contains the water-soluble metal salt of the fatty acid may be reacted to prepare the dispersion liquid in which the inorganic salt S is dissolved and in which the metal soap is contained, or (iii) the aqueous solution which contains the strontium salt and an aqueous solution which contains the water-soluble metal salt of the fatty acid and the inorganic salt S may be reacted to prepare the dispersion liquid in which the inorganic salt S is dissolved and in which the metal soap is contained. From the perspective of further increasing homogeneous solubility, the dispersion liquid preparing step in the case A may be the step of reacting the aqueous solution which contains the strontium salt and the inorganic salt S and the aqueous solution which contains the water-soluble metal salt of the fatty acid to prepare the dispersion liquid in which the inorganic salt S is dissolved and in which the metal soap is contained.

In a case where the cellulose derivative is further mixed in the mixing step (B), the mixing step (B) may be (i) a step of mixing the dispersion liquid of the metal soap, the cellulose derivative, and at least one main agent precursor or (ii) a step of mixing a dispersion liquid in which the cellulose derivative and the metal soap are dispersed and at least one main agent precursor.

### (3-3. Mixing Step (C))

In the mixing step (C), a metal soap which is solid, water, and at least one main agent precursor are mixed.

In the mixing step (C), in place of calcium chloride hexahydrate which is the main agent, at least one selected from the group consisting of calcium chloride anhydride, calcium chloride dihydrate, and calcium chloride tetrahydrate is used as a main agent precursor. As described above, the main agent precursor reacts with water to be calcium chloride hexahydrate which is the main agent. Thus, the mixing step (C) can also be referred to as a step of preparing a mixture containing the calcium chloride hexahydrate and the metal soap, i.e., an inorganic latent heat storage material composition.

The total amount of calcium chloride anhydride, calcium chloride dihydrate, and calcium chloride tetrahydrate used in the mixing step (C) can be set, as appropriate, so that the amount of the calcium chloride hexahydrate in the composition ultimately obtained reaches a desired amount.

The main agent precursor generates heat upon formation of the hydrate, and exhibits positive heat of dissolution. In order to maximize the utilization of the heat generated by hydration of the main agent precursor, it is preferable that the main agent precursor to be mixed with the aqueous solution is solid, not in the form of a solution in which the main agent precursor is pre-dissolved in water. That is, the mixing step (C) may be a step of mixing the metal soap which is solid, water, and at least one solid compound selected from the group consisting of calcium chloride anhydride, calcium chloride dihydrate, and calcium chloride tetrahydrate.

Optionally, water, an inorganic salt S, and/or a cellulose derivative may further be mixed in the mixing step (C). A method and a timing of mixing the water, the inorganic salt S, and/or the cellulose derivative in the mixing step (C) are not particularly limited.

In a case where the inorganic salt S is further mixed in the mixing step (C), the mixing step (C) may be (i) a step of mixing the metal soap, the inorganic salt S, water, and at least one solid compound selected from the group consisting of calcium chloride anhydride, calcium chloride dihydrate, and calcium chloride tetrahydrate or (ii) a step of the metal soap, an aqueous solution which contains the inorganic salt S, and at least one solid compound selected from the group consisting of calcium chloride anhydride, calcium chloride dihydrate, and calcium chloride tetrahydrate.

In a case where the cellulose derivative is further mixed in the mixing step (C), the mixing step (C) may be (i) a step of mixing the metal soap, the cellulose derivative, water, and at least one solid compound selected from the group consisting of calcium chloride dihydrate and calcium chloride tetrahydrate or (ii) a step of mixing the metal soap, a dispersion liquid in which the cellulose derivative is dispersed, and at least one solid compound selected from the group consisting of calcium chloride dihydrate and calcium chloride tetrahydrate.

In any of the mixing steps (A), (B), and (C), the inorganic salt S and/or the cellulose derivative may further be mixed with the mixture (composition) obtained in the mixing step.

In any of the mixing steps (A), (B), and (C), the mixture obtained in the mixing step may be stirred. Alternatively, while any component is stirred, another component may be added to the any component which is being stirred. A device used for stirring is not particularly limited, and a known device may be used, as appropriate. Conditions for the stirring are not particularly limited.

In any of the mixing steps (A), (B), and (C), the mixture obtained in the mixing step may be heated so that production efficiency is improved. A device used for heating is not particularly limited, and a known device may be used, as appropriate. For example, the heating may be carried out with use of a heating means provided to the device used to stir the mixture. The heating temperature of the mixture is not particularly limited. Note that, in a case where the main agent precursor is used as in the mixing steps (B) and (C), the temperature of the mixture can increase due to a reaction between water and the main agent precursor in the mixture obtained in the mixing step. Therefore, in the mixing steps (B) and (C), an advantage similar to that obtained by heating the mixture can be obtained without use of a separate heating means.

### 4. Heat Storage Material

A heat storage material in accordance with one or more embodiments of the present invention need only contain (include) the above-described inorganic latent heat storage material composition. The other configurations, materials, and the like thereof are not limited.

The heat storage material in accordance with one or more embodiments of the present invention can be used as a latent heat type heat storage material due to (i) absorption of thermal energy by the inorganic latent heat storage material composition, which forms the heat storage material, during phase transition of the composition from a solidified state (solid) to a molten state (liquid or gel state) (in other words, melting of the composition) and (ii) absorption of thermal energy by the inorganic latent heat storage material composition, which forms the heat storage material, during phase transition of the composition from a molten state (liquid or gel state) to a solidified state (solid) (in other words, solidification of the composition).

For example, the heat storage material in accordance with one or more embodiments of the present invention can be obtained by charging the above-described inorganic latent heat storage material composition into a container, a bag, or the like.

The container or the bag may be made mainly of a resin (e.g., synthetic resin) from the perspective of preventing leakage of the inorganic latent heat storage material composition due to rusting and corrosion caused by the inorganic latent heat storage material composition. In other words, the heat storage material in accordance with one or more embodiments of the present invention contains the above-described inorganic latent heat storage material composition in accordance with one or more embodiments of the present invention and a resin.

Examples of the resin include polyvinyl chloride, polyethylene, polypropylene, polyethylene terephthalate, polystyrene, nylon, and polyester.

One of these materials may be used alone. Alternatively, two or more of the materials can be used in combination (e.g., by taking on a multilayer structure) in order to improve thermal resistance and barrier performance. From the viewpoint of handling and cost, the container or the bag may be made of polyethylene.

The shape of the container or the bag is not particularly limited. However, from the perspective of efficient heat exchange, via the container or the bag, between the inorganic latent heat storage material composition and a temperature control target article or a space around the temperature control target article, the container or the bag may have a shape that is thin in thickness and that makes it possible to achieve a large surface area. The heat storage material can be formed by charging such a container or such a bag with the inorganic latent heat storage material composition.

Note that more specific examples of the container or the bag include a container or a bag disclosed in Japanese Patent Application Publication Tokukai No. 2015-78307, which is incorporated herein by reference.

The melting temperature, the solidifying temperature, the supercooling temperature, and Δsupercooling of the heat storage material in accordance with one or more embodiments of the present invention can be regarded as identical to the melting temperature, the solidifying temperature, the supercooling temperature, and Δsupercooling, respectively, of the inorganic latent heat storage material composition included in the heat storage material.

Next, the following description will discuss a “transport container”.

### 5. Transport Container

A transport container in accordance with one or more embodiments of the present invention need only contain (include) the above-described heat storage material in accordance with one or more embodiments of the present invention. The other specific configurations, materials, and the like of the transport container are not particularly limited.

FIGS. 1A-1B illustrate an example of the transport container in accordance with one or more embodiments of the present invention. 201 of FIG. 1A is a perspective view schematically illustrating a heat storage material 10 in accordance with one or more embodiments of the present invention. 202 of FIG. 1B is an exploded perspective view schematically illustrating a transport container 1 in accordance with one or more embodiments of the present invention.

As illustrated in 201 and 202 of FIGS. 1A-1B, an opening of the heat storage material 10 in accordance with the present embodiment is closed by a cap 11 of the heat storage material. An inorganic latent heat storage material composition 20 in accordance with one or more embodiments of the present invention is charged into the heat storage material 10 through the opening. The heat storage material 10 can be used while being housed or placed in a thermal insulation container 40. In other words, the transport container in accordance with one or more embodiments of the present invention includes the above-described heat storage material in accordance with one or more embodiments of the present invention and a thermal insulation container.

A material of the heat storage material 10 and a material of the cap 11 for the heat storage material are not particularly limited, and any conventionally known materials can be used as appropriate.

By including, for example, a box 41 and a lid 42 which is fitted into an opening 410 of the box, the thermal insulation container 40 is configured to have a thermal insulation property.

A material of the thermal insulation container 40 is not particularly limited, provided that the material of the thermal insulation container 40 has a thermal insulation property. As the material of the thermal insulation container 40, a foamed plastic is suitably used because the foamed plastic is lightweight and inexpensive and can prevent dew condensation. As the material of the thermal insulation container 40, a vacuum thermal insulation material is also suitably used because the vacuum thermal insulation material has an excellent thermal insulation property, maintains a temperature for an extended period of time, and can prevent dew condensation. Specific examples of the foamed plastic include foamed polyurethane, foamed polystyrene, foamed polyethylene, foamed polypropylene, foamed AS resin, and foamed ABS resin. Examples of the vacuum thermal insulation material include vacuum thermal insulation materials whose cores are made of silica powder, glass wool, glass fiber, or the like. The thermal insulation container 40 may be constituted by a combination of the foamed plastic and the vacuum thermal insulation material. In such a case, the thermal insulation container 40 having high thermal insulation performance can be obtained by, for example, (i) covering, with the vacuum thermal insulation material, an outer surface or an inner surface of each of the box 41 and the lid 42 that are made of the foamed plastic, or (ii) embedding the vacuum thermal insulation material in walls constituting each of the box 41 and the lid 42 that are made of the foamed plastic.

301 of FIG. 2A is a perspective view schematically illustrating the inside of the transport container 1. 302 of FIG. 2B is a cross-sectional view schematically illustrating a cross-section taken along the line A-A in 301 of FIG. 2A.

As illustrated in 202 of FIG. 1B, the thermal insulation container 40 includes the box 41 and the lid 42, and the transport container 1 in accordance with one or more embodiments of the present invention includes the thermal insulation container 40, heat storage materials 10, and spacers 6. In other words, the transport container in accordance with one or more embodiments of the present invention includes the above-described heat storage material in accordance with one or more embodiments of the present invention, a thermal insulation container, and spacers. As illustrated in FIGS. 1A-1B and 2A-2B, in a case where the heat storage materials 10 are housed or placed in the transport container 1, the transport container 1 in accordance with one or more embodiments of the present invention can include the spacers 6 in order to (1) fill a space between (a) a surface of the lid 42 which covers a space in the box, lateral surfaces 412 of the box, and a bottom surface 411 of the box and (b) the heat storage materials 10 and (2) secure a space 5 for accommodating a temperature control target article as illustrated in 302 of FIG. 2B.

Although the transport container 1 includes 10 heat storage materials 10 in FIGS. 1A-1B and 2A-2B, the number of heat storage materials included in the transport container 1 is not particularly limited, provided that at least one heat storage material is included in the transport container 1. The transport container 1 may include two or more heat storage materials 10, four or more heat storage materials 10, six or more heat storage materials 10, or ten or more heat storage materials 10, from the perspective of storing or transporting a temperature control target article at a control temperature for an extended period of time and/or at a control temperature with stability. The number of heat storage materials 10 included in the transport container 1 may be selected as appropriate according to, for example, the size of the heat storage material 10, a period of time for which a temperature control target article is to be stored or transported, and an ambient temperature during storage or transportation of the temperature control target article.

A material of the spacers 6 is not particularly limited and may be, for example, polyurethane, polystyrene, polyethylene, polypropylene, AS resin, ABS resin, and a foamed plastic obtained by foaming such a resin.

According to one or more embodiments of the present invention, a pair of spacers 6 are placed in the thermal insulation container 40 so as to face each other. In a case where the transport container 1 in accordance with one or more embodiments of the present invention includes the spacers 6, a location at which to place the heat storage materials 10 is determined. This makes it possible to facilitate packing. The size and number of spacers 6 included in the transport container 1 are not particularly limited, and can be set as appropriate in accordance with, for example, the sizes of the transport container 1, the heat storage material 10, and a temperature control target article.

In FIGS. 1A-1B and 2A-2B, the transport container 1 includes one space 5 for accommodating a temperature control target article. However, the number of spaces 5 included in the transport container 1 is not particularly limited, provided that the transport container 1 includes at least one space 5. Alternatively, the transport container 1 may include a plurality of spaces 5. For example, separate spaces 5 may be available by placing the heat storage material(s) 10 and/or the spacer(s) 6 in one space 5.

With the transport container in accordance with one or more embodiments of the present invention, an article that requires temperature control (i.e., temperature control target article) can be stored or transported in a state of being maintained at an appropriate control temperature for an extended period of time, regardless of an ambient temperature. Furthermore, since the transport container in accordance with one or more embodiments of the present invention includes the heat storage material including the present inorganic latent heat storage material composition, it is possible to stably exhibit the above appropriate control temperature.

Among temperature control target articles, in storage or transportation of reactive substances, such as adhesives, precision instruments, semiconductors, pharmaceuticals, investigational drugs, and specimens, a control temperature of 15° C. to 30° C. may be required. A control temperature in the transport container in accordance with one or more embodiments of the present invention is not particularly limited, but may be within the range of, for example, 15° C. to 30° C. In other words, the transport container in accordance with one or more embodiments of the present invention may enable a temperature control target article to be maintained within the range of 15° C. to 30° C. for an extended period of time. Thus, the transport container in accordance with one or more embodiments of the present invention can also be referred to as “temperature keeping container”. Example of use applications of the transport container for storing or transporting a temperature control target article while maintaining the temperature control target article at 15° C. to 30° C. include storage and/or transportation of temperature control target articles, e.g., reactive substances, such as adhesives, precision instruments, semiconductors, pharmaceuticals, investigational drugs, and specimens.

Note that, as a more specific configuration of the thermal insulation container, the configuration disclosed in Japanese Patent Application Publication Tokukai No. 2015-78307, which is incorporated herein by reference, can be used.

That is, one or more embodiments of the present invention include the following.

<1> An inorganic latent heat storage material composition containing: calcium chloride hexahydrate; and a metal soap which is composed of strontium ions and anions that are derived from a fatty acid.

<2> The inorganic latent heat storage material composition as described in <1>, further containing at least one inorganic salt selected from the group consisting of bromide salts and chloride salts.

<3> The inorganic latent heat storage material composition as described in <1> or <2>, further containing a lower alcohol.

<4> The inorganic latent heat storage material composition as described in any one of <1> through <3>, wherein the fatty acid is at least one selected from the group consisting of lauric acid, myristic acid, palmitic acid, and stearic acid.

<5> The inorganic latent heat storage material composition as described in any one of <1> through <4>, wherein an amount of the metal soap contained in 100% by weight of the inorganic latent heat storage material composition is 0.01% by weight to 0.10% by weight.

<6> The inorganic latent heat storage material composition as described in any one of <1> through <5>, wherein the metal soap is obtained by reacting an aqueous solution which contains a strontium salt and an aqueous solution which contains a water-soluble metal salt of the fatty acid.

<7> The inorganic latent heat storage material composition as described in <6>, wherein the water-soluble metal salt is at least one selected from the group consisting of sodium salts and potassium salts.

<8> The inorganic latent heat storage material composition as described in any one of <1> through <7>, further containing a cellulose derivative.

<9> A heat storage material including an inorganic latent heat storage material composition described in any one of <1> through <8>.

<10> A transport container including a heat storage material described in <9>.

<11> A method for producing an inorganic latent heat storage material composition, the method including any one of the following mixing steps (A) to (C):
the mixing step (A) of mixing calcium chloride hexahydrate and a metal soap which is composed of strontium ions and anions that are derived from a fatty acid;
the mixing step (B) of mixing a dispersion liquid containing a metal soap which is composed of strontium ions and anions that are derived from a fatty acid and at least one selected from the group consisting of calcium chloride anhydride, calcium chloride dihydrate, and calcium chloride tetrahydrate; and
the mixing step (C) of mixing a metal soap which is composed of strontium ions and anions that are derived from a fatty acid, water, and at least one selected from the group consisting of calcium chloride anhydride, calcium chloride dihydrate, and calcium chloride tetrahydrate.

<12> The method as described in <11>, further including: prior to the mixing step (B), a dispersion liquid preparing step of preparing the dispersion liquid containing the metal soap, by reacting an aqueous solution which contains a strontium salt and an aqueous solution which contains a water-soluble metal salt of the fatty acid, wherein in the mixing step (B), the dispersion liquid which has been prepared in the dispersion liquid preparing step and the at least one selected from the group consisting of calcium chloride anhydride, calcium chloride dihydrate, and calcium chloride tetrahydrate are mixed.

### EXAMPLES

One or more embodiments of the present invention will be described below in more detail with reference to Examples and Comparative Examples. The present invention is not limited to Examples below.

### (Measurement Methods and Evaluation Methods)

Measurement methods and evaluation methods in Examples and Comparative Examples are as below.

### (Melting Temperature)

An inorganic latent heat storage material composition obtained in each of Examples and Comparative Examples was charged, together with a thermocouple, into a polypropylene cryovial having a volume of 2 ml. The cryovial was left to stand in an environment of 5° C. or lower for a certain period of time so that the composition in the cryovial had a temperature of 5° C. or lower and was solidified. The cryovial was then left to stand in an ultra-low temperature thermostatic bath (CRYO PORTER (registered trademark) CS-75CP, available from SCINICS CORPORATION). Next, the temperature of the thermostatic bath was increased from 5° C. to 50° C. at a temperature increase rate of 1.0° C./min. During this period of time, in the process of increasing the temperature of the thermostatic bath, the temperature of the composition in the thermostatic bath was monitored with use of the thermocouple, and obtained results (temperatures) were plotted against time to obtain a graph. In the obtained graph, compared with the temperature of the thermostatic bath which was increased at a constant rate, the temperature of the composition changed in the following order (1) to (3):
(1) the temperature of the composition increased at a constant rate or a substantially constant rate from 5° C. to a certain temperature (regarded as temperature T₁); (2) the temperature of the composition hardly changed from the temperature T₁ to a certain temperature (regarded as temperature T₂) due to the latent heat of the composition; and
(3) the temperature of the composition started increasing again after the temperature T₂.
   The midpoint temperature between the temperature T₁ and the temperature T₂ was calculated as the melting temperature of the composition.

### (Supercooling Temperature and Solidifying Temperature)

The inorganic latent heat storage material composition obtained in each of Examples and Comparative Examples was charged, together with a thermocouple, into the cryovial having a volume of 2 ml. The cryovial was left to stand in an environment of 50° C. or higher for a certain period of time so that the composition in the cryovial had a temperature of 50° C. or higher and was melted. The cryovial was then left to stand in the ultra-low temperature thermostatic bath. Next, the temperature of the thermostatic bath was decreased from 50° C. to 5° C. at a temperature decrease rate of 1.0° C./min. During this period of time, in the process of decreasing the temperature of the thermostatic bath, the temperature of the composition in the thermostatic bath was monitored with use of the thermocouple, and obtained results (temperatures) were plotted against time to obtain a graph. In the obtained graph, compared with the temperature of the thermostatic bath which was decreased at a constant rate, the temperature of the composition changed in the following order (1) to (3):
(1) the temperature of the composition decreased at a constant rate or a substantially constant rate from 50° C. to a certain temperature (regarded as temperature T₄);
(2) after the temperature of the composition slightly increased from the temperature T₄ to a certain temperature (regarded as temperature T₅), the temperature of the composition hardly changed from the temperature T₅ to a certain temperature (regarded as temperature T₆) due to the latent heat of the composition; and
(3) the temperature of the composition started decreasing again after the temperature T₆.
   The temperature T₄ was regarded as the supercooling temperature of the composition, and the temperature T₅ was regarded as the solidifying temperature of the composition. In addition, the difference (temperature difference) between the temperature T₄ (supercooling temperature) and the temperature T₅ (solidifying temperature) was calculated as Δsupercooling (° C.) of the composition.

There also were compositions for which the above (2) and (3) were not observed. This means that, while the temperature of the thermostatic bath was decreased from 50° C. to 5° C. at a temperature decrease rate of 1.0° C./min, each of these compositions did not solidify. For such compositions, “-” was entered in the rows for solidifying temperature, supercooling temperature, and Δsupercooling in Table 2.

### (Evaluation of ΔSupercooling at Initial Stage)

On the basis of the value (° C.) of Δsupercooling at the initial stage (after production and before use (solidification)), the degree of Δsupercooling at the initial stage was evaluated according to the following criteria.
2 (Excellent): Δsupercooling was less than 2.5° C.
1 (Favorable): Δsupercooling was 2.5° C. or more but less than 5.0° C.
0 (Poor): Δsupercooling was 5° C. or more, or the composition did not solidify while the temperature of the thermostatic bath was decreased from 50° C. to 5° C. in the above-described measurement method.

### (Cycle Test)

In order to evaluate the degree of Δsupercooling of the composition after the composition was repeatedly used, a cycle test was carried out by a method including the following (1) to (6):
(1) the composition was charged, together with a thermocouple, into the cryovial;
(2) the cryovial was left to stand in an environment of 5° C. or lower for a certain period of time so that the composition in the cryovial had a temperature of 5° C. or lower;
(3) the cryovial was then left to stand in the ultra-low temperature thermostatic bath;
(4) next, the temperature of the thermostatic bath was increased from 5° C. to 50° C. at a temperature increase rate of 1.0° C./min;
(5) subsequently, the temperature of the thermostatic bath was decreased from 50° C. to 5° C. at a temperature decrease rate of 1.0° C./min; and
(6) the operations (4) and (5) (collectively referred to as a temperature change cycle) were conducted a total of 20 times.
   (Evaluation of ΔSupercooling after Cycle Test)

During the process of the last (20th) temperature change cycle in the above cycle test, the temperature of the composition in the thermostatic bath was monitored with use of the thermocouple, and obtained results (temperatures) were plotted against time to obtain a graph. Then, from the obtained graph, the melting temperature, the solidifying temperature, and the supercooling temperature of the composition were calculated by the above-described methods. Furthermore, Δsupercooling was calculated, and the degree of Δsupercooling after the cycle test was evaluated according to the same criteria as those in the above-described (Evaluation of Δsupercooling at initial stage).

### (Thermal Stability Test)

In order to evaluate the degree of thermal stability of the composition, that is, the degree of Δsupercooling of the composition after a thermal stability test, a thermal stability test was carried out by a method including the following (1) to (5):
(1) the composition was charged, together with a thermocouple, into the cryovial;
(2) the cryovial was left to stand in an environment of 50° C. or higher for 24 hours in a state where the composition in the cryovial had a temperature of 50° C.;
(3) the cryovial was left to stand in an environment of 5° C. or lower for a certain period of time so that the composition in the cryovial had a temperature of 5° C. or lower;
(4) the cryovial was then left to stand in the ultra-low temperature thermostatic bath;
(5) next, the temperature of the thermostatic bath was increased from 5° C. to 50° C. at a temperature increase rate of 1.0° C./min; and
(6) subsequently, the temperature of the thermostatic bath was decreased from 50° C. to 5° C. at a temperature decrease rate of 1.0° C./min.
   (Evaluation of ΔSupercooling after Thermal Stability Test)

During the processes of (5) and (6) in the above thermal stability test, the temperature of the composition in the thermostatic bath was monitored with use of the thermocouple, and obtained results (temperatures) were plotted against time to obtain a graph. Then, from the obtained graph, the melting temperature, the solidifying temperature, and the supercooling temperature of the composition were calculated by the above-described methods. Furthermore, Δsupercooling was calculated, and the degree of Δsupercooling after the thermal stability test was evaluated according to the same criteria as those in the above-described (Evaluation of Δsupercooling at initial stage).

Examples and Comparative Examples are described below.

### Example 1

Water and calcium chloride dihydrate, which is a main agent precursor, were mixed to obtain calcium chloride hexahydrate. Note, here, that the amount of the water to be mixed was adjusted so that the entirety of the water mixed with the calcium chloride dihydrate would react with the entirety of the calcium chloride dihydrate to form calcium chloride hexahydrate.

Subsequently, 97.04 parts by weight of the obtained calcium chloride hexahydrate and 2.91 parts by weight of potassium bromide were added to BeMixer (available from Yasuda Fine Tech Ltd.), and these raw materials in BeMixer were stirred until all the raw materials were completely dissolved and a colorless, transparent mixture was obtained.

Next, 0.05 parts by weight of strontium dilaurate, which is a metal soap, was further added to the obtained mixture, and an obtained mixture was stirred in BeMixer for 10 minutes. By these operations, a composition was obtained. In Table 1, the amount of each component contained in the composition is shown in % by weight. In Table 1, in the rows for fatty acids and water-soluble metal salts of fatty acids, the numbers of carbon atoms in these fatty acids and water-soluble metal salts are indicated after C which is the element symbol of carbon. For example, in the case of lauric acid, it is denoted as “Lauric acid C12” because the number of carbon atoms is 12. The melting temperature, the solidifying temperature, and the supercooling temperature of the obtained composition were calculated at each of the initial stage, after a cycle test, and after a thermal stability test by the above-described methods. Furthermore, the degree of Δsupercooling of the composition was evaluated at each of the initial stage, after the cycle test, and after the thermal stability test. Tables 2 and 3 show these results.

### Examples 2 to 4 and Comparative Examples 1 to 10

A composition of each of Examples 2 to 4 and Comparative Examples 1 to 10 was produced by the same method as that in Example 1, except that the types and the amounts of components blended were changed so that a composition having the composition shown in Table 1 was obtained. In Table 1, the amount of each component contained in the composition is shown in % by weight. Further, as in Example 1, the melting temperature, the solidifying temperature, and the supercooling temperature of the obtained composition were calculated at each of the initial stage, after a cycle test, and after a thermal stability test by the above-described methods. Furthermore, the degree of Δsupercooling of the composition was evaluated at each of the initial stage, after the cycle test, and after the thermal stability test. Tables 2 and 3 show these results.

### Example 5

### (Aqueous Solution Preparing Step)

To BeMixer (available from Yasuda Fine Tech Ltd.), 31.93 parts by weight of water, 0.3 parts by weight of potassium bromide, and 0.1 parts by weight of strontium chloride hexahydrate were added, and these raw materials in BeMixer were stirred until all the raw materials were completely dissolved in the water and a colorless, transparent aqueous solution was obtained. Thereafter, 1.0 part by weight of a 5 (weight/weight) % potassium laurate aqueous solution was added to the obtained aqueous solution, and an obtained mixture was stirred in BeMixer for 10 minutes. By these operations, a dispersion liquid containing strontium dilaurate as a metal soap was obtained.

### (Main Agent Precursor Adding Step)

To the obtained aqueous solution, 67.1 parts by weight of calcium chloride dihydrate was added as a main agent precursor, and an obtained mixture was stirred.

### (Cellulose Derivative Adding Step)

To the obtained mixture, 1.0 part by weight of hydroxyethyl cellulose was added as a cellulose derivative, the temperature of an obtained mixture was increased to 50° C., and the mixture was stirred for 60 minutes while the temperature of the mixture was maintained at 50° C. As a result, a gel-like composition was obtained. In Table 1, the amount of each component contained in the composition is shown in % by weight. The melting temperature, the solidifying temperature, and the supercooling temperature of the obtained composition were calculated at each of the initial stage, after a cycle test, and after a thermal stability test by the above-described methods. Furthermore, the degree of Δsupercooling of the composition was evaluated at each of the initial stage, after the cycle test, and after the thermal stability test. Tables 2 and 3 show these results.

### Examples 6 to 11

A composition of each of Examples 6 to 11 was produced by the same method as that in Example 5, except that the types and the amounts of components blended were changed so that a composition having the composition shown in Table 1 was obtained. In Table 1, the amount of each component contained in the composition is shown in % by weight. Note that the composition of Example 6 contained strontium dimyristate as a metal soap, and the composition of Example 7 contained strontium distearate as a metal soap. The melting temperature, the solidifying temperature, and the supercooling temperature of the obtained composition were calculated at each of the initial stage, after a cycle test, and after a thermal stability test by the above-described methods. Furthermore, the degree of Δsupercooling of the composition was evaluated at each of the initial stage, after the cycle test, and after the thermal stability test. Tables 2 and 3 show these results.

In each of Examples 5 to 11, instead of the main agent (calcium chloride hexahydrate), calcium chloride dihydrate was used as a main agent precursor. The entirety of the calcium chloride dihydrate in a mixture reacted with the entirety of the water in the mixture to form calcium chloride hexahydrate. The amount of the calcium chloride hexahydrate contained in the composition was calculated and is shown in the row “Calcium chloride hexahydrate” in Table 1.

TABLE 1

| | | | Example | Example | Example | Example | Example | Example |
|---|---|---|---|---|---|---|---|---|
| | | | 1 | 2 | 3 | 4 | 5 | 6 |
| Main agent | Calcium chloride hexahydrate | (% by weight) | 97.04 | 99.95 | 98.96 | 97.99 | 96.01 | 96.01 |
| Metal soap | Strontium dilaurate | (% by weight) | 0.05 | 0.05 | 0.05 | 0.05 | — | — |
| Strontium salt | Strontium chloride | (% by weight) | — | — | — | — | 0.10 | 0.10 |
| | Strontium hydroxide | (% by weight) | — | — | — | — | — | — |
| Fatty acid | Octanoic acid C8 | (% by weight) | — | — | — | — | — | — |
| | Decanoic acid C10 | (% by weight) | — | — | — | — | — | — |
| | Lauric acid C12 | (% by weight) | — | — | — | — | — | — |
| Water-soluble | Potassium laurate C12 | (% by weight) | — | — | — | — | 0.05 | |
| metal salt of | Potassium myristate C14 | (% by weight) | — | — | — | — | — | 0.05 |
| fatty acid | Potassium stearate C18 | (% by weight) | — | — | — | — | — | — |
| Inorganic salt S | Potassium bromide | (% by weight) | 2.91 | — | — | — | 2.88 | 2.88 |
| | Potassium chloride | (% by weight) | — | — | 0.99 | 1.96 | — | — |
| | Lithium bromide | (% by weight) | — | — | — | — | — | — |
| | Ammonium chloride | (% by weight) | — | — | — | — | — | — |
| Alcohol | Ethanol | (% by weight) | — | — | — | — | — | — |
| | Glycerin | (% by weight) | — | — | — | — | — | — |
| Cellulose | HEC | (% by weight) | — | — | — | — | 0.96 | 0.96 |
| derivative | | | | | | | | |

| | | | Example | Example | Example | Example | Example |
|---|---|---|---|---|---|---|---|
| | | | 7 | 8 | 9 | 10 | 11 |
| Main agent | Calcium chloride hexahydrate | (% by weight) | 96.01 | 97.90 | 97.90 | 93.33 | 92.46 |
| Metal soap | Strontium dilaurate | (% by weight) | — | — | — | — | — |
| Strontium salt | Strontium chloride | (% by weight) | 0.10 | 0.10 | 0.10 | 0.09 | 0.09 |
| | Strontium hydroxide | (% by weight) | — | — | — | — | — |
| Fatty acid | Octanoic acid C8 | (% by weight) | — | — | — | — | — |
| | Decanoic acid C10 | (% by weight) | — | — | — | — | — |
| | Lauric acid C12 | (% by weight) | — | — | — | — | — |
| Water-soluble | Potassium laurate C12 | (% by weight) | — | 0.05 | 0.05 | 0.05 | 0.05 |
| metal salt of | Potassium myristate C14 | (% by weight) | — | — | — | — | — |
| fatty acid | Potassium stearate C18 | (% by weight) | 0.05 | — | — | — | — |
| Inorganic salt S | Potassium bromide | (% by weight) | 2.88 | — | — | 2.80 | 2.77 |
| | Potassium chloride | (% by weight) | — | — | — | — | — |
| | Lithium bromide | (% by weight) | — | 0.98 | — | — | 0.92 |
| | Ammonium chloride | (% by weight) | — | — | — | — | — |
| Alcohol | Ethanol | (% by weight) | — | — | 0.98 | — | 2.77 |
| | Glycerin | (% by weight) | — | — | — | 2.80 | — |
| Cellulose | HEC | (% by weight) | 0.96 | — | — | — | — |
| derivative | | | | | | | |

| | | | Comparative | Comparative | Comparative | | Comparative |
|---|---|---|---|---|---|---|---|
| | | | Example | Example | Example | Comparative | Example |
| | | | 1 | 2 | 3 | Example 4 | 5 |
| Main agent | Calcium chloride hexahydrate | (% by weight) | 97.09 | 96.62 | 96.62 | 96.16 | 96.16 |
| Metal soap | Strontium dilaurate | (% by weight) | — | — | — | — | — |
| Strontium salt | Strontium chloride | (% by weight) | — | 0.48 | — | 0.48 | 0.48 |
| | Strontium hydroxide | (% by weight) | — | — | 0.48 | — | — |
| Fatty acid | Octanoic acid C8 | (% by weight) | — | — | — | — | — |
| | Decanoic acid C10 | (% by weight) | — | — | — | — | 0.48 |
| | Lauric acid C12 | (% by weight) | — | — | — | 0.48 | — |
| Water-soluble | Potassium laurate C12 | (% by weight) | — | — | — | — | — |
| metal salt of | Potassium myristate C14 | (% by weight) | — | — | — | — | — |
| fatty acid | Potassium stearate C18 | (% by weight) | — | — | — | — | — |
| Inorganic salt S | Potassium bromide | (% by weight) | 2.91 | 2.90 | 2.90 | 2.88 | 2.88 |
| | Potassium chloride | (% by weight) | — | — | — | — | — |
| | Lithium bromide | (% by weight) | — | — | — | — | — |
| | Ammonium chloride | (% by weight) | — | — | — | — | — |
| Alcohol | Ethanol | (% by weight) | — | — | — | — | — |
| | Glycerin | (% by weight) | — | — | — | — | — |
| Cellulose | HEC | (% by weight) | — | — | — | — | — |
| derivative | | | | | | | |
| | | | Comparative | Comparative | Comparative | Comparative | Comparative |
| | | | Example | Example | Example | Example | Example |
| | | | 6 | 7 | 8 | 9 | 10 |
| Main agent | Calcium chloride hexahydrate | (% by weight) | 96.62 | 96.62 | 96.16 | 96.16 | 96.16 |
| Metal soap | Strontium dilaurate | (% by weight) | — | — | — | — | — |
| Strontium salt | Strontium chloride | (% by weight) | — | — | — | — | — |
| | Strontium hydroxide | (% by weight) | — | — | 0.48 | 0.48 | 0.48 |
| Fatty acid | Octanoic acid C8 | (% by weight) | — | — | 0.48 | 0.48 | — |
| | Decanoic acid C10 | (% by weight) | — | — | — | — | 0.48 |
| | Lauric acid C12 | (% by weight) | — | — | — | — | — |
| Water-soluble | Potassium laurate C12 | (% by weight) | — | 0.48 | — | — | — |
| metal salt of | Potassium myristate C14 | (% by weight) | — | — | — | — | — |
| fatty acid | Potassium stearate C18 | (% by weight) | 0.48 | — | — | — | — |
| Inorganic salt S | Potassium bromide | (% by weight) | 2.90 | 2.90 | 2.88 | — | — |
| | Potassium chloride | (% by weight) | — | — | — | — | — |
| | Lithium bromide | (% by weight) | — | — | — | — | — |
| | Ammonium chloride | (% by weight) | — | — | — | 2.88 | 2.88 |
| Alcohol | Ethanol | (% by weight) | — | — | — | — | — |
| | Glycerin | (% by weight) | — | — | — | — | — |
| Cellulose | HEC | (% by weight) | — | — | — | — | — |
| derivative | | | | | | | |

TABLE 2

| | | | Example | Example | Example | Example | Example | Example |
|---|---|---|---|---|---|---|---|---|
| | | | 1 | 2 | 3 | 4 | 5 | 6 |
| Initial stage | Melting temperature | (° C.) | 24.9 | 29.2 | 27.8 | 26.3 | 24.5 | 25.1 |
| | Solidifying temperature | (° C.) | 25.5 | 29.2 | 28.4 | 26.6 | 26.0 | 23.2 |
| | Supercooling temperature | (° C.) | 24.4 | 26.8 | 26.9 | 24.5 | 25.4 | 20.9 |
| | Δsupercooling | (° C.) | 1.0 | 2.4 | 1.6 | 2.1 | 0.6 | 2.4 |
| After cycle test | Melting temperature | (° C.) | 25.0 | 29.4 | 27.9 | 26.7 | 25.1 | 25.2 |
| | Solidifying temperature | (° C.) | 25.1 | 29.2 | 28.4 | 27.0 | 25.4 | 23.6 |
| | Supercooling temperature | (° C.) | 23.9 | 26.9 | 26.2 | 25.3 | 24.5 | 19.3 |
| | Δsupercooling | (° C.) | 1.2 | 2.4 | 2.3 | 1.7 | 0.9 | 4.3 |
| After thermal | Melting temperature | (° C.) | 25.1 | 29.0 | 27.8 | 26.6 | 25.0 | 25.4 |
| stability test | Solidifying temperature | (° C.) | 24.8 | 29.1 | 28.2 | 26.2 | 25.4 | 22.9 |
| | Supercooling temperature | (° C.) | 23.6 | 26.8 | 26.5 | 24.9 | 24.3 | 19.7 |
| | Δsupercooling | (° C.) | 1.2 | 2.2 | 1.7 | 1.4 | 1.1 | 3.3 |

| | | | Example | Example | Example | Example | Example |
|---|---|---|---|---|---|---|---|
| | | | 7 | 8 | 9 | 10 | 11 |
| Initial stage | Melting temperature | (° C.) | 24.8 | 26.7 | 27.4 | 23.9 | 21.6 |
| | Solidifying temperature | (° C.) | 24.2 | 26.5 | 27.1 | 24.4 | 21.5 |
| | Supercooling temperature | (° C.) | 21.1 | 24.0 | 25.5 | 22.1 | 20.0 |
| | Δsupercooling | (° C.) | 3.0 | 2.5 | 1.6 | 2.3 | 1.5 |
| After cycle test | Melting temperature | (° C.) | 25.1 | 26.6 | 27.9 | 23.7 | 21.6 |
| | Solidifying temperature | (° C.) | 23.6 | 26.1 | 27.8 | 23.6 | 21.4 |
| | Supercooling temperature | (° C.) | 20.1 | 22.7 | 25.1 | 21.3 | 19.7 |
| | Δsupercooling | (° C.) | 3.5 | 3.4 | 2.7 | 2.3 | 1.7 |
| After thermal | Melting temperature | (° C.) | 25.2 | 26.8 | 28.1 | 24.2 | 21.9 |
| stability test | Solidifying temperature | (° C.) | 25.2 | 26.2 | 27.9 | 23.1 | 21.2 |
| | Supercooling temperature | (° C.) | 22.6 | 22.4 | 26.4 | 21.5 | 18.8 |
| | Δsupercooling | (° C.) | 2.6 | 3.8 | 1.5 | 1.6 | 2.4 |

| | | | Comparative | Comparative | Comparative | Comparative | Comparative |
|---|---|---|---|---|---|---|---|
| | | | Example | Example | Example | Example | Example |
| | | | 1 | 2 | 3 | 4 | 5 |
| Initial stage | Melting temperature | (° C.) | 24.7 | 24.1 | 25.3 | 25.7 | 25.5 |
| | Solidifying temperature | (° C.) | — | 25.5 | 26.3 | 23.2 | 22.2 |
| | Supercooling temperature | (° C.) | — | 14.6 | 18.0 | 20.1 | 19.8 |
| | Δsupercooling | (° C.) | — | 9.0 | 8.3 | 3.1 | 2.4 |
| After cycle test | Melting temperature | (° C.) | 24.8 | 25.3 | 25.6 | 25.3 | 25.7 |
| | Solidifying temperature | (° C.) | — | 25.2 | 25.6 | — | 26.0 |
| | Supercooling temperature | (° C.) | — | 19.2 | 19.6 | — | 15.0 |
| | Δsupercooling | (° C.) | — | 6.0 | 6.0 | — | 11.0 |
| After thermal | Melting temperature | (° C.) | 25.1 | 25.9 | 25.8 | 24.5 | 25.2 |
| stability test | Solidifying temperature | (° C.) | — | 26.4 | 26.4 | — | 26.0 |
| | Supercooling temperature | (° C.) | — | 18.6 | 19.1 | — | 10.8 |
| | Δsupercooling | (° C.) | — | 7.8 | 7.3 | — | 15.2 |
| | | | Comparative | Comparative | Comparative | Comparative | Comparative |
| | | | Example | Example | Example | Example | Example |
| | | | 6 | 7 | 8 | 9 | 10 |
| Initial stage | Melting temperature | (° C.) | 24.3 | 24.1 | 25.2 | 23.9 | 24.1 |
| | Solidifying temperature | (° C.) | 26.3 | 26.3 | 23.6 | 25.7 | 25.3 |
| | Supercooling temperature | (° C.) | 17.7 | 10.7 | 22.9 | 25.7 | 25.3 |
| | Δsupercooling | (° C.) | 8.6 | 15.6 | 0.7 | 0.1 | 0.0 |
| After cycle test | Melting temperature | (° C.) | 24.5 | 24.2 | 25.4 | 25.1 | 25.3 |
| | Solidifying temperature | (° C.) | 26.2 | 25.0 | 26.6 | 26.2 | 26.3 |
| | Supercooling temperature | (° C.) | 12.8 | 16.8 | 19.3 | 26.2 | 25.9 |
| | Δsupercooling | (° C.) | 13.3 | 8.2 | 7.2 | 0.0 | 0.4 |
| After thermal | Melting temperature | (° C.) | 24.7 | 24.4 | 25.2 | 22.9 | 23.1 |
| stability test | Solidifying temperature | (° C.) | 26.1 | 26.6 | 26.1 | 27.3 | 26.5 |
| | Supercooling temperature | (° C.) | 17.4 | 14.0 | 20.0 | 19.7 | 17.2 |
| | Δsupercooling | (° C.) | 8.7 | 12.5 | 6.1 | 7.6 | 9.3 |

TABLE 3

| | | Example | Example | Example | Example | Example | Example |
|---|---|---|---|---|---|---|---|
| | | 1 | 2 | 3 | 4 | 5 | 6 |
| Initial stage | Δsupercooling | 2 | 2 | 2 | 2 | 2 | 2 |
| After cycle test | | 2 | 2 | 2 | 2 | 2 | 1 |
| After thermal | | 2 | 2 | 2 | 2 | 2 | 1 |
| stability test | | | | | | | |

| | | Example | Example | Example | Example | Example |
|---|---|---|---|---|---|---|
| | | 7 | 8 | 9 | 10 | 11 |
| Initial stage | Δsupercooling | 1 | 1 | 2 | 2 | 2 |
| After cycle test | | 1 | 1 | 1 | 2 | 2 |
| After thermal | | 1 | 1 | 2 | 2 | 2 |
| stability test | | | | | | |

| | | Comparative | Comparative | Comparative | Comparative | Comparative |
|---|---|---|---|---|---|---|
| | | Example | Example | Example | Example | Example |
| | | 1 | 2 | 3 | 4 | 5 |
| Initial stage | Δsupercooling | 0 | 0 | 0 | 1 | 2 |
| After cycle test | | 0 | 0 | 0 | 0 | 0 |
| After thermal | | 0 | 0 | 0 | 0 | 0 |
| stability test | | | | | | |
| | | Comparative | Comparative | Comparative | Comparative | Comparative |
| | | Example | Example | Example | Example | Example |
| | | 6 | 7 | 8 | 9 | 10 |
| Initial stage | Δsupercooling | 0 | 0 | 2 | 2 | 2 |
| After cycle test | | 0 | 0 | 0 | 2 | 2 |
| After thermal | | 0 | 0 | 0 | 0 | 0 |
| stability test | | | | | | |

In one or more embodiments of the present invention, it is possible to provide an inorganic latent heat storage material composition having high thermal stability. The inorganic latent heat storage material composition in accordance with one or more embodiments of the present invention can be suitably used, as a thermal storage material, for example, (i) in wall materials, floor materials, ceiling materials, roof materials, and floor mat base materials and (ii) in constant-temperature transportation applications for temperature control target articles.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. An inorganic latent heat storage material composition comprising:
calcium chloride hexahydrate;
a melting point adjusting agent; and
a metal soap comprising strontium ions and anions derived from fatty acids.

2. The inorganic latent heat storage material composition of claim 1, wherein the melting point adjusting agent comprises an inorganic salt selected from the group consisting of a bromide salt, a chloride salt, and combinations thereof.

3. The inorganic latent heat storage material composition of claim 2, wherein the melting point adjusting agent further comprises a lower alcohol having 5 or less carbon atoms.

4. The inorganic latent heat storage material composition of claim 1, wherein the melting point adjusting agent comprises a lower alcohol having 5 or less carbon atoms.

5. The inorganic latent heat storage material composition of claim 1, wherein the fatty acids are at least one selected from the group consisting of lauric acid, myristic acid, palmitic acid, and stearic acid.

6. The inorganic latent heat storage material composition of claim 1, wherein an amount of the metal soap comprised in 100% by weight of the inorganic latent heat storage material composition is from 0.01% by weight to 0.10% by weight.

7. The inorganic latent heat storage material composition of claim 1, wherein the metal soap is obtained by reacting an aqueous solution comprising a strontium salt and an aqueous solution comprising a water-soluble metal salt of the fatty acids.

8. The inorganic latent heat storage material composition of claim 7, wherein the water-soluble metal salt is at least one selected from the group consisting of sodium salts and potassium salts.

9. The inorganic latent heat storage material composition of claim 1, further comprising a cellulose derivative.

10. A heat storage material comprising the inorganic latent heat storage material composition of claim 1.

11. A transport container comprising the heat storage material of claim 10.

12. A method for producing an inorganic latent heat storage material composition, the method comprising any one of the following mixing steps (A) to (C):
the mixing step (A) of mixing calcium chloride hexahydrate and a metal soap comprising strontium ions and anions derived from fatty acids;
the mixing step (B) of mixing a dispersion liquid comprising a metal soap comprising strontium ions and anions derived from fatty acids, and at least one selected from the group consisting of calcium chloride anhydride, calcium chloride dihydrate, and calcium chloride tetrahydrate; and
the mixing step (C) of mixing a metal soap comprising strontium ions and anions derived from fatty acids, water, and at least one selected from the group consisting of calcium chloride anhydride, calcium chloride dihydrate, and calcium chloride tetrahydrate.

13. The method of claim 12,
further comprising, prior to the mixing step (B), a dispersion liquid preparing step of preparing the dispersion liquid comprising the metal soap, by reacting an aqueous solution comprising a strontium salt and an aqueous solution comprising a water-soluble metal salt of the fatty acids,
wherein, in the mixing step (B), the dispersion liquid prepared in the dispersion liquid preparing step, and the at least one selected from the group consisting of calcium chloride anhydride, calcium chloride dihydrate, and calcium chloride tetrahydrate are mixed.

14. The method of claim 12, wherein the mixing steps (A) to (C) further comprise mixing a melting point adjusting agent.

15. The method of claim 12, wherein the mixing steps (A) to (C) further comprise mixing an inorganic salt selected from the group consisting of a bromide salt, a chloride salt, and combinations thereof.

16. The method of claim 12, wherein the mixing steps (A) to (C) further comprise mixing a lower alcohol having 5 or less carbon atoms.
